(19) United States
(12) Patent Application Publication
(10) Pub. No.: US 2011/0124538 A1
(43) Pub. Date: May 26, 2011

(54) Octylated Phenyl-Alpha-Naphthylamine Product Mixtures And Production Of Such Mixtures Having A High Content Of Octylated Phenyl-Alpha-Naphthylamine

(75) Inventors: Steven G. Karseboom, Baton Rouge, LA (US); Hassan Y. Elnagar, Baton Rouge, LA (US); Vincent J. Gatto, Baton Rouge, LA (US); William E. Moehle, Baton Rouge, LA (US)

(73) Assignee: ALBEMARLE CORPORATION, Baton Rouge, LA (US)

(21) Appl. No.: 13/003,743

(22) PCT Filed: Jul. 21, 2009
(86) PCT No.: PCT/US09/51302

§ 371 Date: Jan. 11, 2011

Related U.S. Application Data
(60) Provisional application No. 61/087,518, filed on Aug. 8, 2008.

(51) Int. Cl. C10M 133/12; C09K 15/22; C10L 1/22

(52) U.S. Cl. 508/563; 252/401; 252/403; 44/426

(57) ABSTRACT

Process technology is described for producing a reaction-derived product mixture containing a high yield of octylated phenyl-alpha-naphthylamine by catalytic alkylation of phenyl-alpha-naphthylamine with diisobutylene. New reaction-derived product mixtures are produced. Also provided are novel reaction-derived octylated phenyl-alpha-naphthylamine reaction product mixtures from which catalyst residues and excess olefin components have been removed. These reaction product mixtures are effective as antioxidants for various oxygen-sensitive substrate materials such as oils and lubricants. Also described are new octylated phenyl-alpha-naphthylamine product mixtures and their use in forming clear, stable, liquid antioxidant compositions for addition to a wide variety of substrates.

### BACKGROUND

It is well known that oils and lubricants are susceptible to oxidative degradation especially during usage at elevated temperatures. Such degradation leads to the formation of organic acids and other deleterious oxygenated products which tend to be corrosive to various metal surfaces with which the oil or lubricant is in contact.

An octylated phenyl alpha-naphthylamine product is known to be effective as an antioxidant which protects oils and lubricants from premature oxidative degradation during use. In U.S. Pat. No. 3,414,618, the production of this product is shown in Example 2 in which the yield was only 62% of theoretical. This low yield presumably is due to the production in the reaction of a complex mixture of products and the difficulty of recovering the desired product from such complex mixture.

It would be of advantage if a way could be found of producing an octylated phenyl-alpha-naphthylamine product mixture in which a high yield of octylated phenyl-alpha-naphthylamine could be formed. It would also be of advantage if a way could be found of facilitating the recovery of an octylated phenyl-alpha-naphthylamine product mixture having a high yield of octylated phenyl-alpha-naphthylamine.

This invention is deemed to provide a way of achieving these objectives.

### BRIEF NON-LIMITING SUMMARY OF THE INVENTION

It has been found that if the reaction conditions used in the alkylation of phenyl-alpha-naphthylamine by diisobutylene are made more severe, surprisingly, the selectivity of the alkylation reaction in forming monooctylated phenyl-alpha-naphthylamine is substantially improved. Indeed, under more severe conditions utilized in the practice of this invention, the reaction-derived product formed after minimal workup which did not alter the chemical compositions of the product mixture in the process, the amounts of (i) diisobutylene dimers, (ii) dialkylated phenyl-alpha-naphthylamine coproducts, and (iii) impurities of presently unknown structures are substantially reduced as compared to use of milder reaction conditions such as were utilized in Example 2 of U.S. Pat. No. 3,414,618. Moreover, the product mixture as formed in the process of this invention contains at least 90 wt % of the desired monooctylated phenyl-alpha-naphthylamine.

The term “reaction-derived” means that the composition of the product is reaction determined and not the result of use of downstream purification techniques, such as recrystallization or chromatography, or other procedures that can modify the chemical structure of one or more of the product components formed in the reaction mixture. Adding water or an aqueous base such as sodium hydroxide to the reaction mixture to inactivate the catalyst and thus alter the chemical makeup of the catalyst, and washing away of non-chemically bound impurities including such water treated catalyst residues by use of aqueous washes such as with water or dilute aqueous bases are not excluded by the term “reaction-derived”. In other words, the products described are those which are directly produced in the synthesis process without use of any subsequent procedure that changes the chemical structure of the principal components of the product mixture as formed in the reaction.

One way of achieving suitably severe conditions in the alkylation process is to employ an aluminum chloride:phenyl-alpha-naphthylamine weight ratio of at least 0.04:1 and conducting the process for at least part of the time at a temperature of at least about 75° C. Another way of achieving suitably severe conditions is to employ a lower aluminum chloride:phenyl-alpha-naphthylamine weight ratio in the range of between about 0.01:1 and about 0.04:1 and conducting the process at a temperature of at least about 80° C., and preferably at least about 90° C. In either case, the temperature used should not be so high as to result in excessive cleavage of reactant or product components, which cleavage can be readily detected by use of gas chromatography. As a general proposition, temperatures up to about 175° C. are deemed suitable even though some cleavage tends to be experienced at somewhat lower temperatures. The amount of such cleavage that is deemed acceptable will of course vary from case to case. Thus, in any instance where a permissible or desirable maximum temperature has not already been established, a few preliminary tests at different reaction temperatures should be used in order to determine a maximum temperature deemed appropriate for the particular reaction mixture being processed. It will of course be understood that the approximate minimum temperatures referred to above need not be maintained throughout the entire reaction period. Thus, the reaction mixture can be continuously or intermittently maintained at such minimum temperature as long as the reaction proceeds to the extent that a desirable product is produced. In addition, it will be understood that when conducting the reaction at elevated temperatures, it is desirable to carry out the reaction under superatmospheric pressure.

This invention thus provides, among other things, a process for producing a reaction-derived product mixture having a high yield of monooctylated phenyl-alpha-naphthylamine, which process comprises heating in a reactor, a reaction mixture formed from phenyl-alpha-naphthylamine, aluminum chloride catalyst, and excess diisobutylene (DIB) wherein the amounts of aluminum chloride and phenyl-alpha-naphthylamine (PANA) that are charged to the reactor are such that (i) the AlCl₃:PANA weight ratio is at least 0.04:1 and the reaction mixture is heated continuously or intermittently at a temperature of at least about 75° C., or (ii) the AlCl₃:PANA weight ratio is in the range of between about 0.01:1 and about 0.04:1 and the reaction mixture is heated continuously or intermittently at a temperature of at least about 80° C., to form a reaction product mixture having a GC assay of at least about 90 GC area % of monooctylated phenyl-alpha-naphthylamine. In conducting this process, the amount of DIB charged to the reactor relative to the amount of PANA charged to the reactor is such that the DIB:PANA molar ratio is in the range of about 1.25:1 to about 10:1, preferably in the range of about 1.25:1 to about 5:1, and more preferably in the range of about 2:1 to about 3:1. In another preferred embodiment, after completion of the reaction, (a) at least a portion of the aluminum chloride catalyst residues and (b) at least a portion of the residual volatile olefin content such as diisobutylene and/or cleavage products thereof are removed from the reaction product mixture. In conducting the removal of (a) and (b), (a) and (b) can be removed either separately or concurrently. To remove (a) and (b) concurrently, the reaction product may be quenched in a hot aqueous medium whereby the catalyst residues are removed in the aqueous phase and the diisobutylene is removed as a vapor. From the standpoint of ease and simplicity of operation, separate removal of (a) and (b) is generally preferable. Typically, (a) is removed separately from the reaction mixture before (b), although the reverse order may be employed.

A particularly preferred embodiment of this invention provides a process as described above wherein the amounts of aluminum chloride and phenyl-alpha-naphthylamine (PANA) that are charged to the reactor are such that the AlCl₃:PANA weight ratio is at least 0.04:1, and wherein the reaction mixture is heated continuously or intermittently at one or more temperatures in the range of about 90° C. to about 175° C., so that the resultant reaction-derived product mixture has a GC assay of at least 95 GC area % of monooctylated phenyl-alpha-naphthylamine. Still another particularly preferred embodiment of this invention is a process as described above wherein the amounts of aluminum chloride and phenyl-alpha-naphthylamine (PANA) that are charged to the reactor are such that the AlCl₃:PANA weight ratio is in the range of between about 0.01:1 to about 0.04:1, and wherein the reaction mixture is heated continuously or intermittently at one or more temperatures in the range of about 80° C. to about 175° C., and preferably in the range of about 90 to about 175° C. so that the resultant reaction-derived product mixture has a GC assay of at least 95 GC area % of monooctylated phenyl-alpha-naphthylamine. In each of these particularly preferred embodiments, it is especially preferred to remove at least a portion of the aluminum chloride catalyst residues and at least a portion of the residual diisobutylene from the reaction product mixture to form a reaction-derived product mixture which, when subjected to gas chromatography analysis, provides a gas chromatogram which shows either no detectable quantity of phenyl-alpha-naphthylamine or a quantity of phenyl-alpha-naphthylamine of no more than 1 GC area %. Such removal operations steps are typically conducted in separate steps, typically with the removal of aluminum catalyst residues preceding removal of isobutylene. The reverse sequence can be used, if desired.

In addition, this invention provides new reaction-derived octylated phenyl-alpha-naphthylamine product compositions suitable for use as antioxidants. These compositions have a DSC melting temperature of about 75° C. or less, a nitrogen content of no less than 4.0 wt %, and comprise the following components in the amounts specified:
A) at least 90 GC area % of monooctylated phenyl-alpha-naphthylamine, and preferably at least 95 GC area % of monooctylated phenyl-alpha-naphthylamine;
B) 1.0 to 4.0 GC area %, and preferably 2.0 to 3.0 GC area % of dioctylated phenyl-alpha-naphthylamine; with the balance, if any, to 100 GC area % being other alkylated products and/or starting materials,
   such GC assay of said composition showing either no detectable quantity of phenyl-alpha-naphthylamine or a quantity of phenyl-alpha-naphthylamine in the range of no more than 2 GC area % and preferably no more than 1 GC area %.

Such product composition is more readily blended with oils and lubricants than essentially pure mono-octylated phenyl-alpha-naphthylamine and is less costly to produce.

This invention also provides certain clear, stable, liquid antioxidant compositions suitable for stabilizing substrates normally susceptible to premature oxidative degradation, especially at elevated temperatures, such as oils and lubricants, as well as other substrates such as liquid fuel compositions.

In addition to being highly cost effective antioxidants for use in oils and lubricants, the reaction-derived products of this invention can be employed as stabilizers for resins, elastomers, and synthetic polymers such as thermoplastic polymers.

Other embodiments, features, and advantages of this invention will be still further apparent from the ensuing description and appended claims.

### FURTHER DETAILED DESCRIPTION OF EMBODIMENTS OF THE INVENTION

The process technology of this invention for producing reaction-derived product mixtures having a high yield of monooctylated phenyl-alpha-naphthylamine involves the discovery that by using an increased ratio of aluminum chloride catalyst to phenyl-alpha-naphthylamine (PANA), the reaction product will contain a substantially greater percentage of octylated phenyl-alpha-naphthylamine. In fact, after deactivating the catalyst and removing the resultant impurities, and removing excess olefins that may be present in the mixture, the entire remaining product mixture itself can be utilized as an antioxidant composition. Thus, in contrast to the results shown in U.S. Pat. No. 3,414,618, in which the yield of octylated phenyl-alpha-naphthylamine was reported to be 62% of theoretical, products containing as much as about 95 GC area % of octylated phenyl-alpha-naphthylamine have been produced.

Although an ancillary liquid reaction solvent can be used, it is preferred to conduct the reaction using the excess diisobutylene (DIB) as the reaction solvent, as this simplifies process operations. Thus, in conducting the process, the amount of DIB charged to the reactor relative to the amount of PANA charged to the reactor can vary as long as a stoichiometric excess theoretically required to produce mono-octylated phenyl-alpha-naphthylamine is employed. Preferably, the molar ratio of DIB to PANA used in the reaction is in the range of about 1.25:1 to about 5:1, and more preferably in the range of about 2:1 to about 3:1.

As noted above, this invention also provides a process for the production of an octylated phenyl-alpha-naphthylamine product mixture capable of producing an antioxidant product composition suitable for use as an antioxidant. In this embodiment of the invention, the above process for increasing the percentage of octylated phenyl-alpha-naphthylamine in the reaction product mixture is utilized as the first step of the process. Then, in order to form the antioxidant product mixture, aluminum chloride catalyst residues and residual diisobutylene are removed from the reaction product mixture in separate operations. Once this is accomplished a composition of this invention serving as a highly effective antioxidant for substrates susceptible to oxidative degradation, especially oils and lubricants, remains as the product. Thus, antioxidant product formation and recovery are relatively simple and economical.

A preferred way of removing the aluminum chloride catalyst residues from the reaction product mixture involves quenching the reaction mixture with an aqueous quenching liquid which can be simply water itself. By quenching the entire reaction mixture into water, the aluminum chloride catalyst residues dissolve in the aqueous phase which then may be separated from the organic phase. In conducting the quenching operation, the water desirably contains a small amount of a Brønsted acid such as hydrochloric acid and it is desirable to transfer the mother liquor into the aqueous quench rather than vice versa. Both of these techniques help to ensure that the aluminum chloride residues will be soluble in the aqueous phase which in turn leads to a cleaner phase separation. Typically, the resultant product mixture will contain at most only trace amounts of aluminum.

To remove excess DIB (and solvent, if used) a procedure such as distillation, flashing, or zone refining can be used. If distillation or flashing is used, it is desirable to operate at reduced pressure in order to reduce the likelihood of thermal cleavage.

An optional additional step which can be utilized in the practice of this invention enables the production of a highly pure octylated phenyl-alpha-naphthylamine product. Before conducting such a crystallization procedure, it is desirable to ensure that the amount of DIB, if any, remaining in the reaction product mixture is at a very low level. Such residual DIB if present in sufficient quantities can cause the octylated phenyl-alpha-naphthylamine to oil out of solution rather than to crystallize A preferred crystallization procedure involves use of a secondary alkanol in admixture or combination with water. Secondary butyl alcohol and isopropyl alcohol have been found to be desirable alkanols for use in the crystallization operation with isopropyl alcohol being the more preferred of the two. However, other liquid secondary alcohols may be used. The ratio of secondary alcohol to water may range from about 40:60 to as high as about 99.5:0.5 with values between about 60:40 and about 95:5 being preferred. At lower ratios, yields are improved but at the expense of purity. At the higher ratios, purity is improved at the expense of yield. The temperatures at which the crystallization occurs may depend somewhat upon the secondary alcohol medium employed. With isopropyl alcohol, a temperature in the range of about −10° C. to about 175° C. is favored. Ideally the starting temperature of the crystallization should be high enough so that all of the octylated phenyl-alpha-naphthylamine product mixture is dissolved in the crystallization medium. Once the material has been crystallized, it may be filtered, optionally washed, and then dried to afford a final highly purified octylated phenyl-alpha-naphthylamine product. Such product is in the form of low-dust particles. Further details concerning such low-dust octylated phenyl-alpha-naphthylamine products and their preparation are described and claimed in co-pending commonly-owned U.S. Application No. 61/087,523, filed contemporaneously herewith as Case G1-7800, entitled Low-Dust Octylated Phenyl-Alpha-Naphthylamines and Formation Thereof.

The following Examples are presented for purposes of illustration. They are not intended to limit the scope of the invention to only that which is disclosed therein.

Example 1 illustrates a process of this invention in which a high percentage of monooctylated phenyl-alpha-naphthylamine is formed in the reaction product. Example 1 also illustrates the first stage of a three stage process of this invention which produces a crude octylated phenyl-alpha-naphthylamine product mixture of this invention. Examples 2 and 3 illustrate the second and third stages of the three stage process of this invention, respectively.

### EXAMPLE 1

### Production of Octylated Phenyl-alpha-Naphthylamine Reaction Product

Into a 3L round bottom flask equipped with a heating mantle, thermowell, overhead stirrer, and nitrogen pad was charged 800 g of phenyl-alpha-naphthylamine (PANA) (98.7 wt %; 3.55 moles). The material was heated with stirring to ˜100° C. so that the PANA was molten and near the ultimate reaction temperature. Once at temperature, a total of 35.7 g anhydrous aluminum chloride (0.27 moles; 0.075 equivalents) was charged with stirring. After 5 minutes, a total of 1012 g of diisobutylene (>99%; 9.02 moles; 2.54 equivalents) was added all at once with stirring causing the temperature to fall to ˜55° C. After the temperature recovered to ˜100° C., the reaction mass was held at temperature for 6.5 hours to achieve >99% conversion of starting material based upon GC area %.

### EXAMPLE 2

### Quench and Wash of Organic Phase

In order to quench and wash the product mixture, the equipment used was a 3L round bottom flask equipped with heating mantle, nitrogen pad, thermowell, and overhead stirrer. Into the so-equipped flask was charged 300 g of 1% hydrochloric acid. The mixture was heated to >˜65° C. to ensure that octylated phenyl-alpha-naphthylamine would not precipitate during the quench. The reaction mixture produced above was added with stirring to the hydrochloric acid solution over about 5 minutes. The resulting mixture was heated to and maintained at ˜85° C. for 20 minutes. Then, agitation was stopped and the phases were allowed to separate. The denser organic phase was saved while the aqueous phase was discarded. The organic phase was washed for 20 minutes at ˜80° C. with 200 g of 0.5 wt % aqueous caustic to aid in removing residual salts. The two phases were allowed to separate, and the denser organic was recovered for removal of excess diisobutylene.

### EXAMPLE 3

### Removal of Unreacted Diisobutylene

In order to remove unreacted diisobutylene from the organic phase formed in Example 2, the organic phase was placed into a 3L round bottom flask equipped with a heating mantle, thermowell, stir bar, and overhead condenser maintained at ˜1° C. via a cooling bath. The pressure of the system was reduced to ˜300 Torr and then heating was applied. Material began to flash overhead at ˜65° C. Heating was continued until the pot temperature reached ˜150° C. at which point the system pressure was slowly lowered to ˜15 Torr while still maintaining the temperature at ˜150° C. The residues from this operation constitutes a reaction product mixture of this invention that contains at least about 90% of the desired product.

Example 4 illustrates an optional crystallization procedure for preparing a highly purified octylated phenyl-alpha-naphthylamine product having low-dust characteristics.

### EXAMPLE 4

### Crystallization of Non-Distilled Residues Remaining After DIB Removal

Into a 5L jacketed round bottom flask equipped with nitrogen pad, overhead stirrer, and thermowell was charged 1272 g of crude octylated-phenyl-alpha-naphthylamine produced by alkylation of phenyl-alpha-naphthylamine with diisobutylene using aluminum chloride as catalyst. To this crude product 2397 g of a 85 wt. % solution of isopropyl alcohol in water was added and the mixture was heated to >65° C. to dissolve all of the solids and to form a single liquid phase. Optionally, a small amount of sodium borohydride or similar reducing agent may be added at this point to improve coloration of the final product, should this be desired. Once at temperature, the mixture is slowly cooled until the pot temperature is <40° C. Seed crystals may be added during the cool down to induce nucleation. Once at <40° C., 435 g of water was added over 30 minutes to bring the overall ratio of isopropyl alcohol to water to 72:28 w/w to improve the isolated yield of octylated phenyl-alpha-naphthylamine. The mixture was filtered, washed with 60:40 w/w isopropyl alcohol:water, and then vacuum dried at 50° C. to afford 1101 g crystallized octylated phenyl-alpha-naphthylamine (97.0 wt % via internal standard, 97.9 wt % upon normalization of sample; 90.8% molar yield from starting PANA after accounting for analytical samples removed during process). Coloration was off white to pinkish. The product was in the form of small spheroids.

EXAMPLE 5

Into a 100 gallon glass-lined reactor was charged 220 lb of phenyl-alpha-naphthylamine and 10 lb of aluminum chloride. The reactor was heated to 100° C. under nitrogen and 279.5 lb of diisobutylene was charged to the molten phenyl-alpha-naphthylamine at such a rate that the reaction temperature was always above 90° C. The reaction mixture was held 95-105° C. for 6 hours. The reaction mixture was charged to a reactor containing 80 lb of 1-2% aqueous hydrochloric acid. After stirring at 80° C. for one hour, the aqueous layer was removed and the organic phase was washed with 80 lb (36.3 kg) of water at 80° C. Diisobutylene was stripped off to final conditions of 100 mm Hg and 170° C. and the molten product was cooled to a solid at room temperature. GC analysis showed more than 93 area % of a desired product mixture of this invention.

Also provided by this invention are liquid antioxidant compositions containing a phenyl-alpha-naphthylamine product mixture of this invention. Such compositions are suitable for use in protecting various substrate materials normally susceptible to oxidative degradation, especially at elevated temperatures. Such mixtures are illustrated by the following:
AA) A clear liquid octylated phenyl-alpha-naphthylamine additive composition which comprises a blend of:
i) an octylated phenyl-alpha-naphthylamine composition of this invention in an amount of about 50 to about 60 parts by weight;
ii) sterically hindered phenolic antioxidant in an amount of about 100 parts by weight; and
iii) aromatic hydrocarbon fluid in an amount of about 40 to about 70 parts by weight, said hydrocarbon fluid having (1) an aromatics content according to ASTM test method D 1319 of at least 95% by volume, (2) a distillation range according to ASTM test method D 86 in which the initial boiling temperature is in the range of about 220 to about 235° C. and a final boiling temperature is in the range of about 265 to about 285° C., and (3) a flash point according to ASTM test method D 93A of greater than 100° C.;
   wherein said sterically hindered phenolic antioxidant contains (a) in the range of about 50 to 100% by weight of sterically hindered phenolic antioxidant having a hydrocinnamic acid ester functional group in the para-position, with the balance to 100%, when (a) is not 100%, being 2,6-di-tert-butylphenol; and wherein the foregoing amounts result in the formation of a clear liquid octylated phenyl-alpha-naphthylamine additive composition at 25° C.
BB) An additive composition as in AA) wherein said sterically hindered phenolic antioxidant contains 100% by weight of sterically hindered phenolic antioxidant having a hydrocinnamic acid ester functional group in the para-position.
CC) An additive composition as in AA) wherein said sterically hindered phenolic antioxidant contains at least 50 wt % but less than 100% by weight of hindered phenolic antioxidant having a hydrocinnamic acid ester functional group in the para-position with the balance to 100% being 2,6-di-tert-butylphenol.

A preferred sterically hindered phenolic antioxidant having a hydrocinnamic acid ester functional group in the para-position for use in the above compositions is available in the marketplace as Ethanox® 4716 Antioxidant (Albemarle Corporation). The other sterically hindered phenolic antioxidant, 2,6-di-tert-butylphenol, is also available commercially, for example, as Ethanox® 4701 (Albemarle Corporation).

A preferred aromatic hydrocarbon fluid meeting the above requirements is available commercially from ExxonMobil Chemical Corporation as Aromatic 200 ND Fluid. Other typical values for the product as given by the manufacturer are color by ASTM D 1500, Light 0.5; Kauri-Butanol value by ASTM D 1133 of 99, a specific gravity by ASTM D 4052 of 0.996 (at 15.6° C.), a mixed aniline point by ASTM D 611 of 12; a surface tension by ASTM D 1331 of 36 dynes/cm; and a viscosity at 25° C. by ASTM D 445 of 2.74 cSt.

The above liquid antioxidant compositions are clear, stable blends well suited for blending with oils, lubricants, and greases. They also can be effectively utilized as stabilizers for elastomers and synthetic macromolecular materials such as resins and polymers, and for liquid fuel compositions such as gasolines, diesel fuels, jet fuels, and burner fuels.

To demonstrate the stability of these liquid antioxidant compositions, several samples of such compositions were placed in 8-ounce screw cappable glass jars and subjected to gentle heating to facilitate blending. The samples were then allowed to stand at ambient temperature in the capped jars for various periods of time in order to determine their stability as reflected by their ability to remain as clear blends without any visible content of crystals or small particles. The components used in these operations were as follows:
(a) an octylated phenyl-alpha-naphthylamine mixture formed as in Example 3;
(b) a sterically hindered phenolic antioxidant having a hydrocinnamic acid ester functional group in the para-position (ETHANOX® 4716 Antioxidant; Albemarle Corporation);
(c) 2,6-di-tert-butylphenol (ETHANOX® 4701 Antioxidant; Albemarle Corporation);
(d) a hydrocarbon fluid referred to above having a typical aromatics content according to ASTM test method D 1319 of 99.9% by volume (Aromatic 200 ND Fluid; ExxonMobil Chemical Company).

The results of these operations are summarized in the Table in which the numerical values for the components are parts by weight used in making the blends.

TABLE

| Sample | Compo- | Compo- | Compo- | Compo- | Storage | Blend |
|---|---|---|---|---|---|---|
| Number | nent (a) | nent (b) | nent (c) | nent (d) | Time* | Appearance |
| 1 | 50 | 50 | 50 | 50 | 40 days | Clear |
| 2 | 50 | 100 | — | 50 | 31 days | Clear |
| 3 | 55 | 55 | 55 | 35 | 17 days | Clear |
| 4 | 55 | 110 | — | 35 | 17 days | Clear |
| 5 | 80 | — | — | 120 | 17 days | Clear |

*The storage times shown are as of a date shortly prior to the filing of this application. The tests on each of the blends were still continuing at that time.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure.

The invention may comprise, consist or consist essentially of the materials and/or procedures recited herein.

This invention is susceptible to considerable variation in its practice. Therefore the foregoing description is not intended to limit, and should not be construed as limiting, the invention to the particular exemplifications presented hereinabove.

1. A process for producing a reaction-derived product mixture having a high yield of monooctylated phenyl-alpha-naphthylamine, which process comprises heating in a reactor, a reaction mixture formed from phenyl-alpha-naphthylamine, aluminum chloride catalyst, and excess diisobutylene (DIB) wherein the amounts of aluminum chloride and phenyl-alpha-naphthylamine (PANA) that are charged to the reactor are such that the AlCl₃:PANA weight ratio is at least 0.04:1 and the reaction mixture is heated continuously or intermittently at a temperature of at least about 75° C., to form a reaction product mixture having a GC assay of at least about 90 GC area % of monooctylated phenyl-alpha-naphthylamine.

2. A process as in claim 1 wherein the amount of DIB charged to the reactor relative to the amount of PANA charged to the reactor is such that the DIB:PANA molar ratio is in the range of about 1.25:1 to about 5:1.

3. A process as in claim 1 wherein after completion of the reaction (a) aluminum chloride catalyst residues and (b) residual diisobutylene and other olefin impurities are removed from the reaction product mixture to thereby form a reaction-derived product mixture that provides a GC assay showing either no detectable quantity of phenyl-alpha-naphthylamine or a quantity of phenyl-alpha-naphthylamine of no more than 2 GC area %.

4. A process as in claim 3 wherein (a) is separately removed from the reaction mixture before (b).

5. A process as in claim 1 wherein the reaction mixture is heated continuously or intermittently at one or more temperatures in the range of about 90° C. to about 175° C., so that the resultant reaction-derived product mixture has a GC assay of at least 95 GC area % of monooctylated phenyl-alpha-naphthylamine.

6. A process as in claim 5 wherein after completion of the reaction (a) at least a portion of the aluminum chloride catalyst residues and (b) at least a portion of the residual diisobutylene and other olefin impurities are removed from the reaction product mixture to thereby form a reaction-derived product mixture that provides a GC assay showing either no detectable quantity of phenyl-alpha-naphthylamine or a quantity of phenyl-alpha-naphthylamine of no more than 1 GC area %.

7-8. (canceled)

9. A reaction-derived product composition suitable for use as an antioxidant, which composition has a DSC melting temperature of about 75° C. or less, has a nitrogen content of no less than 4.0 wt %, and which composition, on the basis of a GC assay, comprises:
A) at least 90 GC area % of monooctylated phenyl-alpha-naphthylamine; and
B) 1.0 to 4.0 GC area % of dioctylated phenyl-alpha-naphthylamine, with the balance, if any, to 100 GC area % being other alkylated products and/or starting materials,
such GC assay of said composition showing either no detectable quantity of phenyl-alpha-naphthylamine or a quantity of phenyl-alpha-naphthylamine of no more than 2 GC area %.

10. A product composition as in claim 9 wherein the amounts of said components A) and B), on the basis of said GC assay, are:
A) at least 95 GC area % of monooctylated phenyl-alpha-naphthylamine and
B) 2.0 to 3.0 GC area % of dioctylated phenyl-alpha-naphthylamine,
such GC assay of said composition showing either no detectable quantity of phenyl-alpha-naphthylamine or a quantity of phenyl-alpha-naphthylamine of no more than 1 GC area %.

11. A clear liquid additive composition which comprises a blend of:
i) a reaction-derived product composition as in claim 9 in an amount of about 50 to about 60 parts by weight;
ii) sterically hindered phenolic antioxidant in an amount of about 100 parts by weight; and
iii) aromatic hydrocarbon fluid in an amount of about 40 to about 70 parts by weight, said hydrocarbon fluid having (1) an aromatics content according to ASTM test method D 1319 of at least 95% by volume, (2) a distillation range according to ASTM test method D 86 in which the initial boiling temperature is in the range of about 220 to about 235° C. and a final boiling temperature is in the range of about 265 to about 285° C., and (3) a flash point according to ASTM test method D 93A of greater than 100° C.;
wherein said sterically hindered phenolic antioxidant contains (a) in the range of about 50 to 100% by weight of sterically hindered phenolic antioxidant having a hydrocinnamic acid ester functional group in the para-position, with the balance to 100%, when (a) is not 100%, being 2,6-di-tert-butylphenol; and wherein the foregoing amounts result in the formation of a clear liquid octylated phenyl-alpha-naphthylamine additive composition at 25° C.

12. An additive composition as in claim 11 wherein said sterically hindered phenolic antioxidant contains 100% by weight of sterically hindered phenolic antioxidant having a hydrocinnamic acid ester functional group in the para-position.

13. An additive composition as in claim 11 wherein said sterically hindered phenolic antioxidant contains at least 50 wt % but less than 100% by weight of hindered phenolic antioxidant having a hydrocinnamic acid ester functional group in the para-position with the balance to 100% being 2,6-di-tert-butylphenol.

14. A composition which comprises an oil or lubricant with which has been blended in an amount sufficient to inhibit premature oxidative degradation thereof, a composition as in claim 9.

15. A composition which comprises a liquid fuel composition with which has been blended in an amount sufficient to inhibit premature oxidative degradation thereof, a composition as in claim 9.

16. A process as in claim 2 wherein after completion of the reaction (a) aluminum chloride catalyst residues and (b) residual diisobutylene and other olefin impurities are removed from the reaction product mixture to thereby form a reaction-derived product mixture that provides a GC assay showing either no detectable quantity of phenyl-alpha-naphthylamine or a quantity of phenyl-alpha-naphthylamine of no more than 2 GC area %.

17. A process as in claim 16 wherein (a) is separately removed from the reaction mixture before (b).

18. A process as in claim 2 wherein the reaction mixture is heated continuously or intermittently at one or more temperatures in the range of about 90° C. to about 175° C., so that the resultant reaction-derived product mixture has a GC assay of at least 95 GC area % of monooctylated phenyl-alpha-naphthylamine.

19. A process as in claim 18 wherein after completion of the reaction (a) at least a portion of the aluminum chloride catalyst residues and (b) at least a portion of the residual diisobutylene and other olefin impurities are removed from the reaction product mixture to thereby form a reaction-derived product mixture that provides a GC assay showing either no detectable quantity of phenyl-alpha-naphthylamine or a quantity of phenyl-alpha-naphthylamine of no more than 1 GC area %.

20. A clear liquid additive composition which comprises a blend of:
i) a reaction-derived product composition as in claim 10 in an amount of about 50 to about 60 parts by weight;
ii) sterically hindered phenolic antioxidant in an amount of about 100 parts by weight; and
iii) aromatic hydrocarbon fluid in an amount of about 40 to about 70 parts by weight, said hydrocarbon fluid having (1) an aromatics content according to ASTM test method D 1319 of at least 95% by volume, (2) a distillation range according to ASTM test method D 86 in which the initial boiling temperature is in the range of about 220 to about 235° C. and a final boiling temperature is in the range of about 265 to about 285° C., and (3) a flash point according to ASTM test method D 93A of greater than 100° C.;
wherein said sterically hindered phenolic antioxidant contains (a) in the range of about 50 to 100% by weight of sterically hindered phenolic antioxidant having a hydrocinnamic acid ester functional group in the para-position, with the balance to 100%, when (a) is not 100%, being 2,6-di-tert-butylphenol; and wherein the foregoing amounts result in the formation of a clear liquid octylated phenyl-alpha-naphthylamine additive composition at 25° C.
